(19) United States
(12) Patent Application Publication
(10) Pub. No.: US 2026/0297330 A1
(43) Pub. Date: Oct. 1, 2026

(54) HIGHER-MOLECULAR PHOTOCHROMIC DYES HAVING AT LEAST ONE AND NOT MORE THAN FOUR NAPHTHOPYRAN SUBUNITS AND MULTIPLE POLYETHER CHAINS

(71) Applicant: Rodenstock GmbH, München (DE)

(72) Inventors: Andreas HARTL, München (DE); Udo WEIGAND, München (DE); Herbert ZINNER, Rohrbach (DE)

(21) Appl. No.: 19/475,465

(22) PCT Filed: Apr. 10, 2024
(86) PCT No.: PCT/EP2024/059715

§ 371 Date: Oct. 15, 2025

(30) Foreign Application Priority Data
Apr. 18, 2023 (DE) 10 2023 109 737.7

(51) Int. Cl. C09B 69/10; G02B 1/04; G02B 5/23; G02C 7/10

(52) U.S. Cl. CPC C09B 69/10; G02B 1/041; G02B 5/23; G02C 7/10

(57) ABSTRACT

The present invention relates to novel higher-molecular photochromic dyes with at least one and at most four naphthopyran subunits and multiple polyether chains, to their use, as well as to phototropic acrylate, allyl carbonate, urea, urethane, or thiourethane polymers containing them, and to a phototropic product.

The present invention relates to novel higher-molecular photochromic dyes with at least one and at most four naphthopyran subunits and multiple polyether chains, to phototropic acrylate, allyl carbonate, urea, urethane, or thiourethane polymers containing them, to a phototropic product, as well as to the use of these photochromic dyes.

Thiourethane polymers are by far the most widely used materials for plastic spectacles with higher refractive indices of ≥1.60. The higher the refractive index, the thinner a corrective spectacle lens can be manufactured. So far, however, it has not been possible to incorporate photochromic dyes directly into thiourethane polymers without the use of special additives and to generate acceptable phototropic properties (deep darkening upon exposure to sunlight combined with rapid brightening after the end of exposure). The reason for this is that the dense, densely three-dimensionally cross-linked polymer matrix of the thiourethane thermoset polymers used for high-quality plastic spectacles leaves no room for the photochromic dyes to undergo a reversible transformation-induced by long-wave UV radiation—from their colorless basic state to their darkened state. Therefore, conventional photochromic dyes in thiourethane thermoset polymers do not darken in sunlight, or only to a negligible extent. For this reason, surface coating with photochromic coatings-primarily by spin coating—has so far been the method of choice for producing phototropic plastic spectacles with higher refractive indices. However, this method has the disadvantage that it requires complex and expensive technical equipment and that only a relatively small number of products can be produced per unit of time, which results in relatively high production costs.

Various classes of dyes have long been known that reversibly change color upon irradiation with long-wave UV light, particularly sunlight. This is due to the fact that these photochromic dye molecules, due to light energy, transform from their colorless basic state (“closed form”)-accompanied by selective bond rupture-into a darkened state (“open form”), from which they return to the colorless basic state upon interruption of the energy supply, reforming the previously broken bond. The most widely used class of dye for use in photochromic spectacles is naphthopyran systems, particularly with further annelated aromatic rings, which, due to the larger conjugated system, absorb longer wavelengths in both the closed and open colored forms. A benzene ring with an additional bridging in the ortho position is typically used for annelation. In the compounds according to the invention presented below, the benzene ring is annelated to the R₉ substituents via a monoatomic bridge (with the R₇ and R₈ substituents) or via a diatomic bridge (with the R₇, R₈, and R₁₀ substituents).

If a monoatomic bridging is present, a five-membered ring is annelated to the naphthopyran (“indeno-naphthopyrans”). Examples can be found in EP 0 792 468 and EP 0 906 366. EP 0 912 908, EP 2 457 915, EP 2 471 794, EP 2 684 886, EP 2 788 340, and EP 2 872 517 describe compounds in which at least one further ring system is annelated to the indenonaphthopyran core structure. EP 3 807 258 describes doubly indeno-annelated naphthopyran systems that have longer-chain polyether substituents to improve the phototropic properties.

If a diatomic bridging is present, a six-membered ring annelated to the naphthopyran (“dihydronaphtho-naphthopyrans”) results, as described in EP 1 119 560, EP 2 829 537, and EP 3 010 924. Such compounds with longer-chain polyether substituents are also described in the aforementioned EP 3 807 258.

The present invention is therefore based on the object of providing novel photochromic dyes, the direct incorporation of which particularly into thiourethane thermoset polymers is to lead to phototropic polymers characterized by outstanding phototropic properties without the mandatory need for any special additives. With the help of the new photochromic dyes, outstanding photochromic properties (extremely deep darkening upon exposure to sunlight combined with extremely rapid brightening after the end of exposure) can be realized in a matrix-independent manner, not only in the high-index range but also for low-index lenses.

This object is achieved by the subject matters characterized in the claims.

The present invention is based on the surprising finding that certain photochromic dye molecules with multiple polyether chains at different points of the molecule, which contains between one and four naphthopyran subunits, exhibit excellent matrix-independent phototropic properties in all types of plastic spectacles, in contrast to systems with only one naphthopyran subunit and one polyether chain, as described in the aforementioned EP 3 807 258. Furthermore, this is achieved without the need for special additives, without the help of which dyes with only one naphthopyran subunit and one longer-chain polyether substituent exhibit only unacceptable phototropic properties in densely cross-linked thiourethane thermoset polymers.

EP 2 714 767 describes photochromic dyes with two (or more) naphthopyran subunits linked to one another by a high-molecular polyester chain. Furthermore, EP 2 705 071 describes photochromic dyes with two (or more) naphthopyran subunits linked to one another by high-molecular polymer chains of various types. However, the compounds described in these two documents also only exhibit acceptable phototropic properties in thiourethane thermoset polymers with the additional use of additives, as they contain only one linear polymer chain. In contrast, in the compounds according to the invention, the naphthopyran subunits—in the case of more than one of them in the molecule—are linked to one another only by relatively short linkers, while multiple higher-molecular polyether chains are each attached “outside” the molecule. This allows these longer-chain polyether substituents to very efficiently encapsulate the photochromic naphthopyran subunits, thus completely shielding them from the respective plastic-lens polymer matrix. This makes it possible for the first time to realize excellent photochromic properties independently of the matrix-even in densely cross-linked thiourethane thermoset polymers.

According to the invention, novel higher-molecular photochromic dyes with at least one and at most four naphthopyran subunits as well as multiple polyether chains according to the following formula (I) are thus provided:

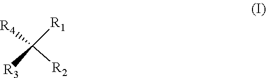

on the proviso (1) that at least one and at most four of the radicals R₁, R₂, R₃, and R₄, independently of one another, represent the following group A with a terminal, longer-chain polyether substituent:

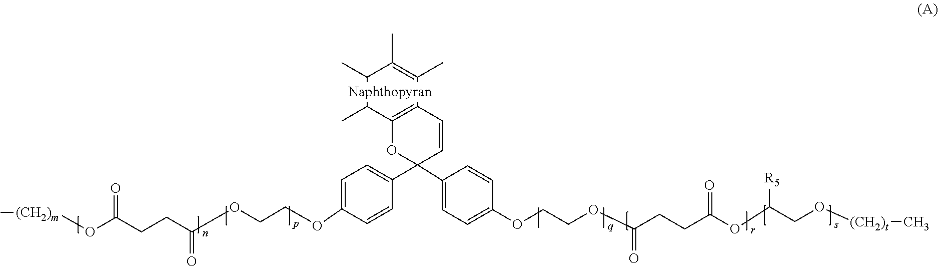

and the remaining radicals R₁, R₂, R₃, and R₄, independently of one another, represent hydrogen, a methyl radical, an ethyl radical, a phenyl radical, or the following group B with a longer-chain polyether substituent:

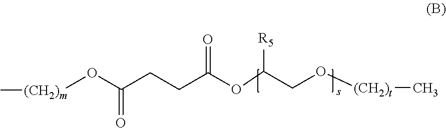

wherein, in the case of only one group A in the molecule, at least one of the remaining radicals must represent the group B;

or on the proviso (2) that at least one and at most two of the radicals R₁, R₂, R₃, and R₄, independently of one another, represent the following group C:

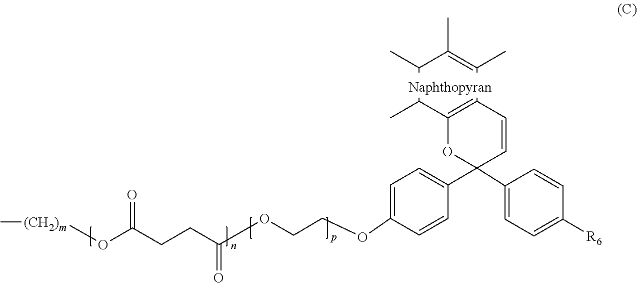

and of the remaining radicals R₁, R₂, R₃, and R₄, at least two represent the group B, wherein in the case of a further remaining radical, it can be selected from hydrogen, a methyl radical, an ethyl radical, or a phenyl radical;

wherein m, n, p, q, and r, independently of one another, represent an integer from 0 to 1, s represents an integer from 5 to 50, and t represents an integer from 0 to 3,

wherein the stylized benzene ring inscribed “naphthopyran” represents one of the four following discrete naphthopyran subunits “1“−“4”:

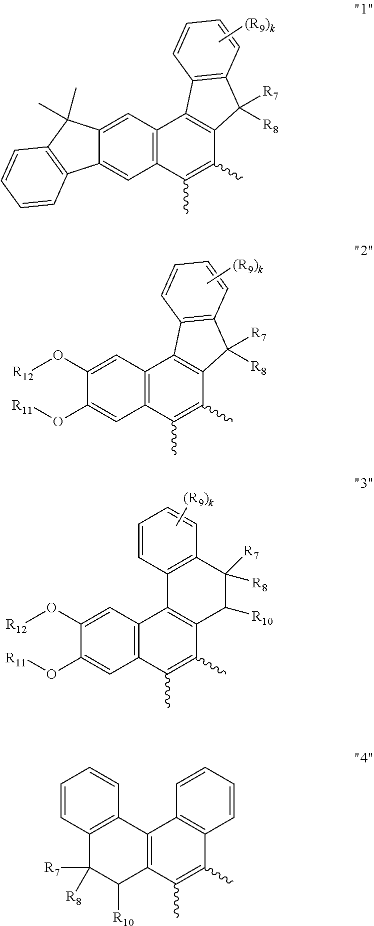

and wherein the above substituents R₅, R₆, R₇, R₈, R₉, R₁₀, R₁₁, and R₁₂ are as defined in claim 1.

A further subject matter of the present invention relates to photochromic acrylate, allyl carbonate, urea, urethane, or thiourethane polymers comprising one or more of the above photochromic dyes.

The present invention also relates in particular to a phototropic product based on such a thiourethane polymer, which is a two-component system in which a 0.1 mm to 1 mm thin phototropic polythiourethane functional layer based on the thiourethane polymer is polymerized onto a polymer base body, or is a sandwich system in which a 0.1 mm to 1 mm thin phototropic polythiourethane functional layer based on the thiourethane polymer is arranged between two polymer bodies.

Even a further subject matter of the present invention relates to the use of the photochromic dyes according to the invention for incorporation into thiourethane polymers, in particular for ophthalmic purposes, in lenses and glasses for spectacles of all kinds, such as corrective spectacles, driving spectacles, ski goggles, sunglasses, motorcycle goggles, for visors of protective helmets, and the like, and for sun protection purposes in vehicles and in the construction sector, in the form of windows, protective visors, covers, roofs, and the like.

The compounds according to the invention are characterized in that the photochromic naphthopyran subunits are located in spatial proximity to two or more polyether chains. The arrangement of these subunits around a central, tetrahedral carbon atom makes it possible for the entire system to be spatially encapsulated from the polymer matrix. This spatial shielding of the phototropic naphthopyran subunits with the aid of the longer-chain polyether substituents enables matrix-independent phototropic properties for the first time, which specifically means that with the compounds according to the invention, phototropic properties in thiourethanes, urethanes, ureas, acrylates, and allyl carbonates can be achieved.

So far, to achieve good phototropic properties, either specially adapted polymer matrices with less dense cross-linking-associated with lower hardnes-had to be used, or special additives had to be added. These additives, together with the dyes, form domain systems that locally soften the polymer matrix. However, the formation of these domains is very material-specific and can only be realized in certain polymer matrices. The special structure of the compounds according to the invention, however, allows the longer-chain polyether substituents to arrange themselves in close proximity to the pyran ring of the photochromic naphthopyran subunits. This is the point of the greatest structural change during photochromic switching when opening to the colored form or closing back to the colorless form. Due to the loose arrangement (“random coil”) of the linear polyether chains with only minimal intramolecular interactions, this opening and closing of the photochromic center is not hindered. The photochromic properties of the dyes according to the invention can thus also be realized in highly cross-linked polymer matrices such as thiourethane polymers.

Due to the special structure of the dyes and their “separation” from the surrounding polymer matrix, the photochromic dyes according to the invention can achieve excellent darkening upon exposure to sunlight and extremely rapid brightening after the end of exposure.

Bonding of the naphthopyran subunits to the central, tetrahedral carbon atom of formula (I) occurs either directly (for n=p=0), via a succinyloxy bridge (for n=1 and p=0), or via an ethyleneoxy-succinyloxy bridge (for n=p=1).

The use of a succinyloxy bridge is advantageous in that, when modern coupling reagents are used, ester bonds can be formed at very mild reaction temperatures (including room temperature), i.e. without thermal stress on the molecule upon heating and the resulting thermal decomposition reactions. Other coupling reactions, such as Williamson ether syntheses, require higher reaction temperatures and more drastic reaction conditions (e.g., the use of strong bases).

The use of an ethyleneoxy bridge between the naphthopyran subunit and the succinyloxy bridge is generally necessary if an even higher brightening rate is to be achieved. The brightening from the darkened state is generally faster for naphthopyran systems the better the electron-donor properties of the substituents on the two benzene rings bonded to the carbon atom next to the pyran oxygen. Therefore, it is advantageous to use two strongly electron-donating alkoxy substituents, since the acyloxy substituent of a succinyloxy bridge directly on the naphthopyran subunit is too weak an electron donor, thus often resulting in an insufficient brightening rate. The same applies to a succinyloxy bridge (for r=1) as a link between the naphthopyran subunit and the longer-chain polyether substituent in the compounds according to the invention, to which proviso (1) applies.

Compounds according to the invention, to which proviso (1) applies, have between one and four naphthopyran subunits and a total of two to four longer-chain polyether substituents (distributed across groups A and B). The latter are each linked to the adjacent naphthopyran subunits via optional ethyleneoxy (for q=1) and succinyloxy bridges (for r=1) or, in the case of fewer than four naphthopyran subunits in the molecule, are optionally additionally attached directly to the central, tetrahedral carbon atom of formula (I), specifically as group B, linked via a succinyloxy bridge. This non-optional succinyloxy bridge in group B is again present for synthetic reasons. The coupling of the longer-chain polyether substituents to the central, tetrahedral carbon atom is achieved here via ester bridges under very mild reaction conditions.

Compounds according to the invention, to which proviso (2) applies, have either one or two naphthopyran subunits and either two or three longer-chain polyether substituents. The latter are each linked to the naphthopyran subunits via the central, tetrahedral carbon atom as group B. In contrast to proviso (1), no further longer-chain polyether substituents are bonded to the naphthopyran subunits, but only “smaller” substituents R₆, with the aid of which the darkening color and the brightening rate can be influenced.

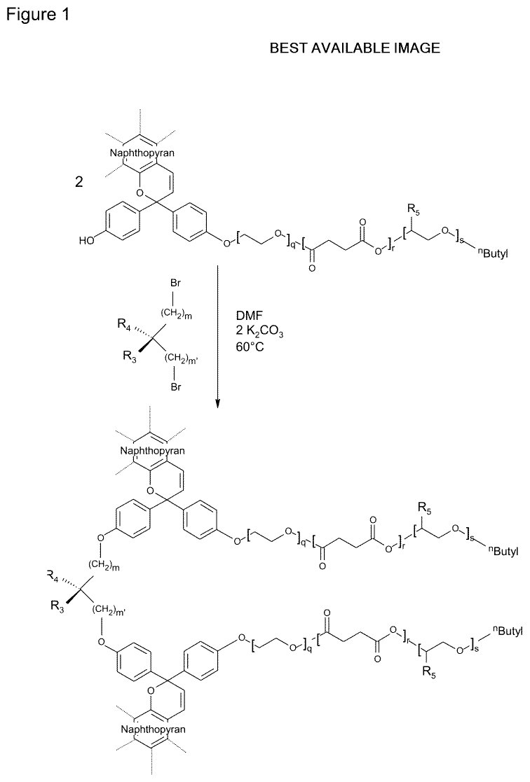

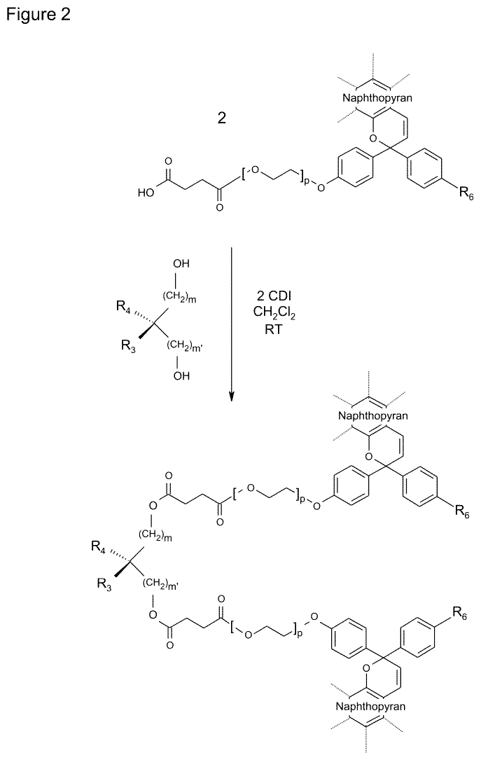

For the synthesis of the compounds according to the invention, suitable naphthopyran starting compounds known in principle from the prior art can be used and reacted, for example, with 1,3-difunctional propane derivatives (wherein m=m′=1) according to FIGS. 1 and 2 to form molecules each with two naphthopyran subunits and at least two longer-chain polyether substituents.

FIG. 1 shows a synthesis scheme of the compounds according to the invention with two naphthopyran subunits, to which proviso (1) applies.

The starting compounds used here are naphthopyrans, each with a 4-hydroxy substituent on one of the two benzene rings, which are bonded to the carbon atom next to the pyran oxygen, and a longer-chain polyether substituent on the other benzene ring, bonded via optional ethyleneoxy (for q=1) and succinyloxy bridges (for r=1). Suitable polyether substituents particularly include commercially available longer-chain polypropylene glycol monobutyl ethers, but also polypropylene glycol/polyethylene glycol copolymers with monoalkyl caps. The chain lengths exhibit a Gaussian distribution, i.e. mixtures with different chain lengths distributed around a maximum are present. The covalent coupling of two molecules of these naphthopyran starting compounds via a central, tetrahedral carbon atom is carried out by a Williamson ether synthesis using 1,3-dibromopropane derivatives (wherein m=m′=1). Alternatively, 1,2-dibromoethane (wherein R₃=R₄=H, m=1, and m′=0) can also be used.

If one uses 2-(bromomethyl)-1,3-dibromopropane derivatives (R₃=CH₂Br), three molecules of the naphthopyran starting compounds can be converted into compounds according to the invention containing three naphthopyran subunits. Accordingly, bis(2-bromomethyl)-1,3-dibromopropane (R₃=R₄=CH₂Br) and four molecules of the naphthopyran starting compounds yield compounds according to the invention with four naphthopyran subunits.

FIG. 2 shows a synthesis scheme of the compounds according to the invention, to which proviso (2) applies.

The starting compounds used here are naphthopyran starting compounds with a 4-succinyloxy substituent and an optional ethyleneoxy bridge (for p=1) on one of the two benzene rings, which are bonded to the carbon atom next to the pyran oxygen, as well as the para-substituent R₆ on the other benzene ring. The covalent coupling of two molecules of these naphthopyran starting compounds via a central, tetrahedral carbon atom is achieved by a mild ester synthesis using 1,1′-carbonyldiimidazole (CDI) and 1,3-propanediol derivatives, which have two longer-chain polyether substituents (R₃=R₄=group B). These 2,2-substituted 1,3-propanediol derivatives are relatively easily accessible from the inexpensive precursor pentaerythritol.

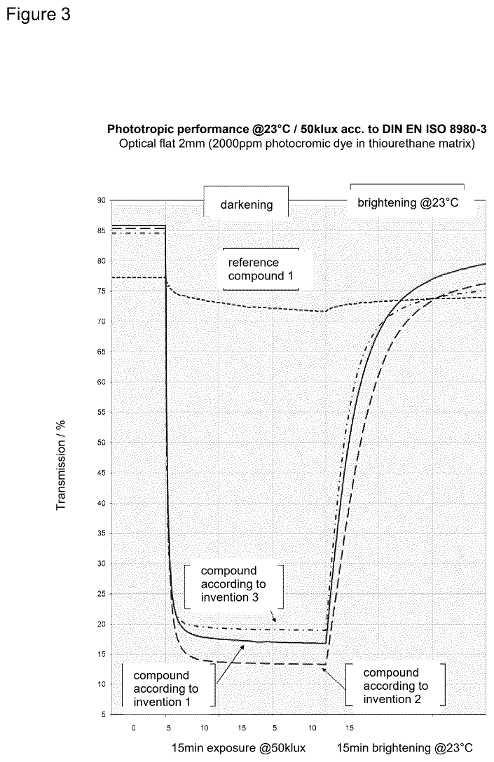

FIG. 3 shows a comparison of the phototropic performance of three compounds according to the invention with a suitable reference compound from the prior art (EP 3 807 258). The compounds all contain the naphthopyran subunit “1”—the other claimed naphthopyran subunits behave absolutely analogously in such comparisons. The transmission data in FIG. 3 are from measurements carried out according to DIN EN ISO 8980-3 at 23° C.

Polythiourethane discs with a thickness of 2 mm were used for the measurements. They were produced by dissolving the photochromic dyes in a liquid monomer mixture consisting of isocyanates and thiols suitable for high-quality plastic spectacles and thermally polymerizing them in a mold after addition of a standard Sn catalyst.

The specific molecular structures of the compounds shown in FIG. 3 are listed in Table 1. Compounds 1 and 2 according to the invention are derived from formula 1, proviso 1, and compound 3 according to the invention is derived from formula 1, proviso 2.

TABLE 1

| Compound | Structural formula | Substituents |
|---|---|---|
| Reference compound (prior art) | 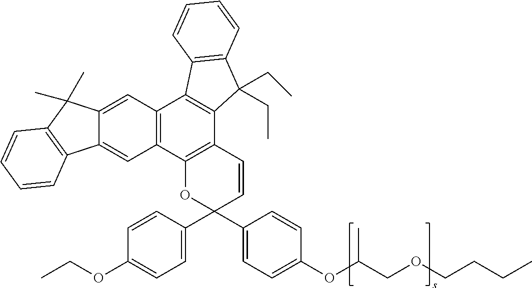 | s ≈ 16 (Gaussian distribution) |
| Compound according to the invention 1 | 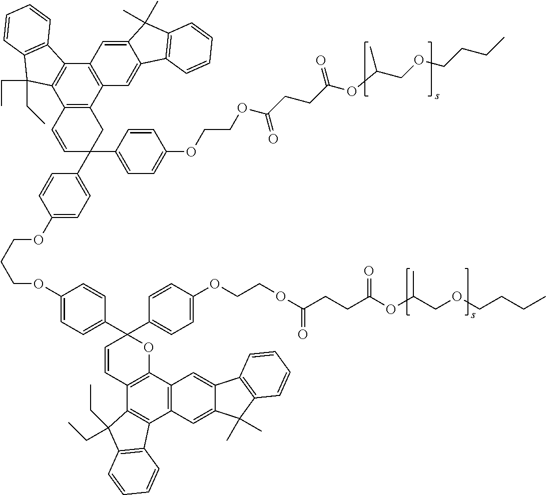 | According to formula 1, proviso 1: R₃ = R₄ = H R₁ = R₂ = group A with m = 1, n = 0, q = 1, r = 1, s ≈ 16 (Gaussian distribution), t = 3, R₅ = methyl. naphthopyran “1”: R₇ = R₈ = ethyl; k = 0 |
| Compound according to the invention 2 | 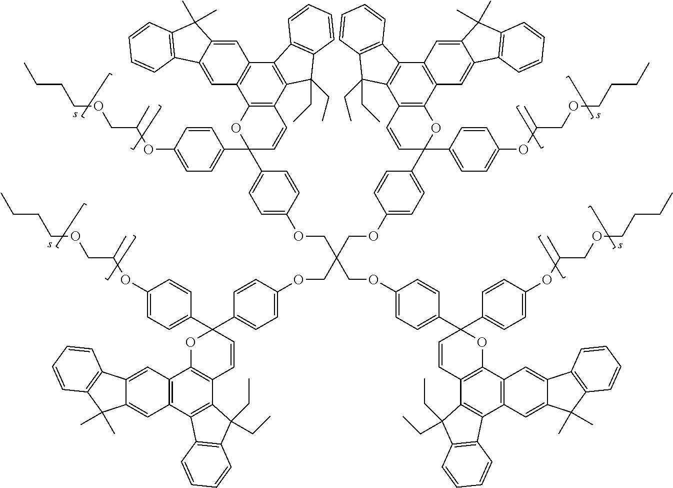 | According to formula 1, proviso 1: R₁ = R₂ = R₃ = R₄ = group A with m = 1, n = 0, p = 0, q = 0, r = 0, s ≈ 16 (Gaussian distribution), t = 3, R₅ = methyl. napthopyran “1”: R₇ = R₈ = ethyl; k = 0 |
| Compound according to the invention 3 | 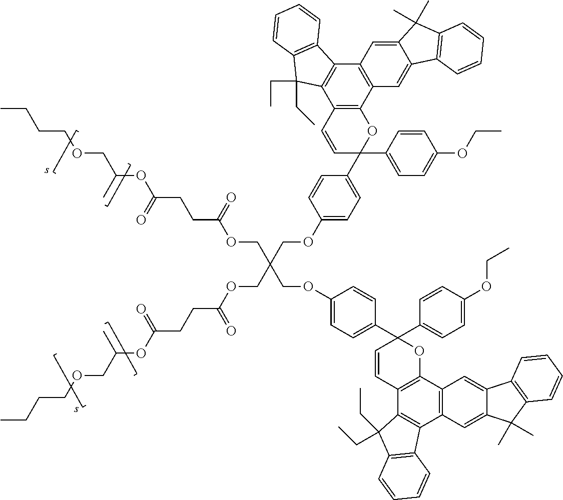 | According to formula 1, proviso 2: R₁ = R₂ = group C with m = 1, n = 0, p = 0, R₆ = ethoxy R₃ = R₄ = group B with m = 1, s ≈ 16 (Gaussian distribution), t = 3, R₅ = methyl. napthopyran “1”: R₇ = R₈ = ethyl; k = 0 |

The inventive compound 1 in Table 1 has two naphthopyran subunits linked via a 1,3-propanediol bridge. The polypropylene glycol chains on each of the naphthopyran subunits are linked via a glycol and a succinyloxy bridge.

The inventive compound 2 in Table 1 has four naphthopyran subunits linked via a pentaerythritol bridge. The polypropylene glycol chains on each naphthopyran subunit are directly linked to the naphthopyran subunits via an ether bond.

The inventive compound 3 in Table 1 has two naphthopyran subunits linked to a pentaerythritol central molecule. A polypropylene glycol chain is bonded to each of the other two alcohol groups of the pentaerythritol via a succinyloxy bridge.

The reference compound, in contrast, has only one polypropylene glycol chain and one naphthopyran subunit, thus reflecting the prior art. Here, the naphthopyran subunit is identical to those of compounds 1-3 according to the invention.

The results presented in FIG. 3 clearly show that the exact structure of the naphthopyran subunit plays only a minor role in the present invention. The reference compound exhibits virtually no phototropic properties and only a minimal change in transmission after irradiation with UV light. The phototropic properties of such compounds can only be developed by using highly adapted matrices or special additives.

In contrast, compounds 1, 2, and 3 according to the invention exhibit good darkening depth with transmission values below 20% in the fully excited state. The arrangement of multiple naphthopyran subunits and polyether chains around a common center guarantees an optimal environment for the dyes and thus enables the development of photochromic properties even in polythiourethane polymers that are not optimized for this purpose, without the use of special additives.

In addition, the reference compound exhibits a relatively low transmission value in the unexcited state of only approximately 77%. This indicates the presence of the open, colored form of the photochromic dyes, which have no ability to return to the colorless basic state. This problem was also resolved by the inventive compounds 1, 2, and 3, since the dyes are not prevented from reverse reaction to the colorless basic state without illumination, thus allowing significantly higher transmission to be achieved in the brightened state.

The inventive compounds 1, 2, and 3 also exhibit a very rapid brightening behavior.

These excellent photochromic properties (high transmission in the brightened state, deep darkening upon exposure, and very rapid brightening) can be realized not only in polythiourethane matrices, but also in other matrices suitable for use in plastic spectacles, such as polyurethanes, poly(meth)acrylates, or polyallyl carbonates. Photochromic dye systems exhibiting such matrix independence-without the need for additional additives—have thus been provided for the first time.

1. Photochromic dyes with at least one and at most four naphthopyran subunits and multiple polyether chains according to the following formula (I): 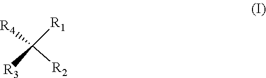
on the proviso (1) that at least one and at most four of the radicals R₁, R₂, R₃, and R₄, independently of one another, represent the following group A with a terminal, longer-chain polyether substituent: 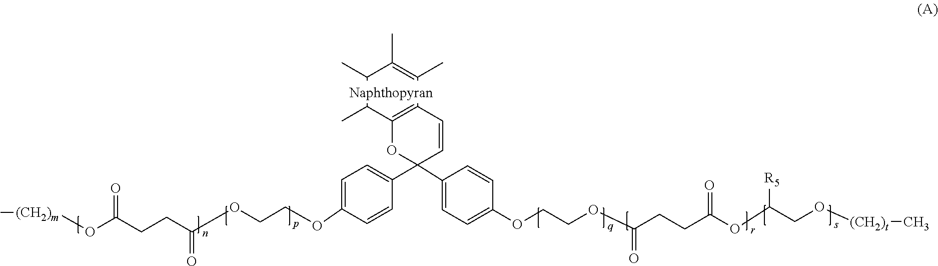
and the remaining radicals R₁, R₂, R₃, and R₄, independently of one another, represent hydrogen, a methyl radical, an ethyl radical, a phenyl radical, or the following group B with a longer-chain polyether substituent: 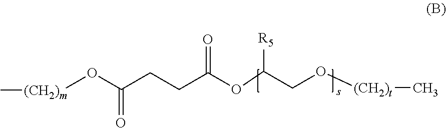
wherein, in the case of only one group A in the molecule, at least one of the remaining radicals must represent the group B;
or on the proviso (2) that at least one and at most two of the radicals R₁, R₂, R₃, and R₄, independently of one another, represent the following group C: 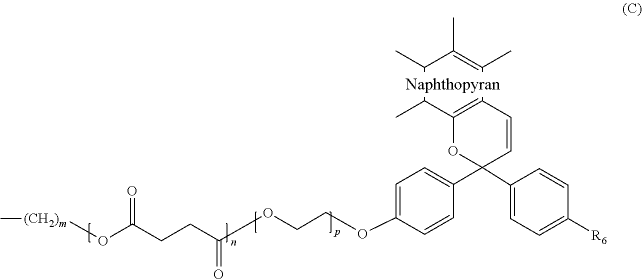
and of the remaining radicals R₁, R₂, R₃, and R₄, at least two represent the group B, wherein in the case of a further remaining radical, it can be selected from hydrogen, a methyl radical, an ethyl radical, or a phenyl radical;
wherein m, n, p, q, and r, independently of one another, represent an integer from 0 to 1, s represents an integer from 5 to 50, and t represents an integer from 0 to 3,
wherein the radical R₅ in the repeating unit of chain length s, independently of one another, represent hydrogen or a methyl radical;
wherein the radical R₆ represents a substituent selected from hydrogen, fluorine, a (C₁-C₆)-alkyl radical, a (C₃-C₇)-cycloalkyl radical, a (C₁-C₆)-thioalkyl radical, a (C₁-C₆)-alkoxy radical, a trifluoromethyl radical, a phenyl radical, a 4-methoxyphenyl radical, a phenoxy radical, a 4-methoxyphenoxy radical, a benzyl radical, a 4-methoxybenzyl radical, a benzyloxy radical, a 4-methoxybenzyloxy radical, a biphenyl radical, a biphenyloxy radical, a naphthyl radical, a naphthoxy radical, a piperidinyl radical, a 3,5-dimethylpiperidinyl radical, a morpholinyl radical, a 2,6-dimethylmorpholinyl radical, a thiomorpholinyl radical, an azacycloheptyl radical, an indolinyl radical, a 1,2,3,4-tetrahydroquinolinyl radical, a 1,2,3,4-tetrahydroisoquinolinyl radical, a diphenylamino radical, a ((C₁-C₆)-alkoxyphenyl)-phenylamino radical, a bis ((C1-C6)-alkoxyphenyl) amino radical, a 10,10-dimethyl-9,10-dihydroacridine radical, a phenothiazinyl radical, a phenoxazinyl radical, a phenazinyl radical, a carbazolyl radical, a 1,2,3,4-tetrahydrocarbazolyl radical, or a 10,11-dihydro-dibenz [b,f]azepinyl radical;
wherein the stylized benzene ring inscribed “naphthopyran” represents one of the four following discrete naphthopyran subunits “1“−“4”: 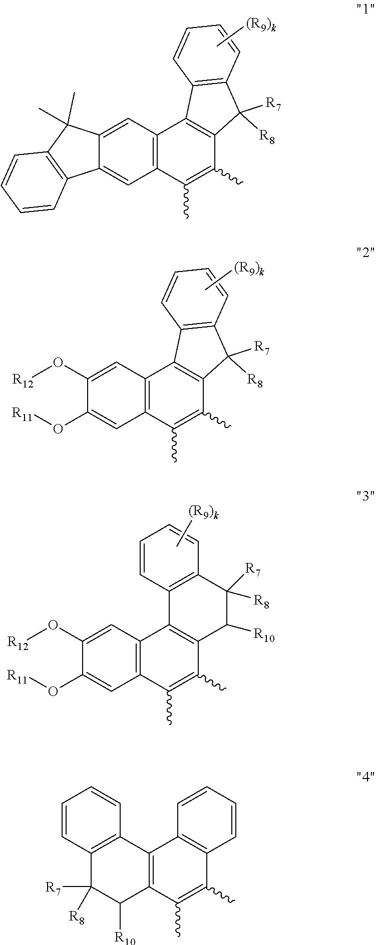
wherein the radicals R₇, R₈, and R₁₀, independently of one another, represent a substituent selected from a (C₁-C₆)-alkyl radical or a phenyl radical;
the radicals R₉, independently of one another, represent a substituent selected from a (C₁-C₆)-alkyl radical, a (C₃-C₇)-cycloalkyl radical, a (C₁-C₆)-alkoxy radical, a benzyl radical, or an unsubstituted or monosubstituted phenyl radical, wherein the substituent can be selected from fluorine, a (C₁-C₆)-alkyl radical, or a (C₁-C₆)alkoxy radical; and wherein k represents 0, 1, or 2:
or two adjacent R₉ radicals together form an annelated benzene ring, which can be unsubstituted, monosubstituted, or disubstituted, wherein the substituents can be selected from a (C₁-C₆)-alkyl radical, a (C₁-C₆)-alkoxy radical, a phenyl radical, or a benzyl radical;
or two adjacent R₉ radicals together form an annelated naphthalene ring system, an annelated benzofuran ring system, an annelated benzothiophene ring system, an annelated 3,3-dimethylindene ring system, or an annelated 2H-chromene ring system;
and the radicals R₁₁ and R₁₂, independently of one another, represent a substituent selected from hydrogen, a (C₁-C₆)-alkyl radical, a (C₃-C₇)-cycloalkyl radical, a trifluoromethyl radical, a benzyl radical, or an unsubstituted or monosubstituted phenyl radical, wherein the substituent can be selected from fluorine, a (C₁-C₆)-alkyl radical, or a (C₁-C₆)-alkoxy radical;
or the radicals R₁₁ and R₁₂ together represent the group —(CH₂)ⱼ—, wherein j represents an integer from 1 to 3; on the proviso that if this numerical value is 2 or 3, a benzene ring may also be annelated to two adjacent CH₂ groups.

2. Photochromic dyes according to claim 1, wherein the dyes are characterized by proviso (1).

3. Photochromic dyes according to claim 1, wherein the dyes are characterized by proviso (2).

4. Photochromic dyes according to claim 1, wherein the stylized benzene ring inscribed “naphthopyran” is selected from one of the above naphthopyran subunits “1”, “2”, or “3”.

5. Photochromic dyes according to claim 1, wherein the radicals R₉, independently of one another, represent a substituent selected from a (C₁-C₆)-alkyl radical, a (C₃-C₇)-cycloalkyl radical, a (C₁-C₆)-alkoxy radical, a benzyl radical, or an unsubstituted or monosubstituted phenyl radical, wherein the substituent can be selected from fluorine, a (C₁-C₆)-alkyl radical, or a (C₁-C₆)-alkoxy radical; and wherein k represents 0, 1, or 2.

6. Photochromic dyes according to claim 1, wherein the radicals R₁₁ and R₁₂, independently of one another, represent a substituent selected from hydrogen, a (C₁-C₆)-alkyl radical, a (C₃-C₇)-cycloalkyl radical, a benzyl radical, or an unsubstituted or monosubstituted phenyl radical, wherein the substituent may be selected from fluorine, a (C₁-C₆)-alkyl radical, or a (C₁-C₆)-alkoxy radical.

7. A phototropic acrylate, allyl carbonate, urea, urethane, or thiourethane polymer comprising one or more of the photochromic dyes according to claim 1.

8. A phototropic product based on a thiourethane polymer according to claim 7, which is a two-component system in which a 0.1 mm to 1 mm thin phototropic polythiourethane functional layer based on the thiourethane polymer is polymerized onto a polymer base body, or is a sandwich system in which a 0.1 mm to 1 mm thin phototropic polythiourethane functional layer based on the thiourethane polymer is arranged between two polymer bodies.

9. A thiourethane polymer comprising one or more of the photochromic dyes according to claim 1.

10. A product comprising the thiourethane polymer of claim 9 selected from lenses, glasses, goggles, a visor, sunglasses, a window, roofing material, or a cover.
